(19) United States
(12) Patent Application Publication
(10) Pub. No.: US 2016/0139694 A1
(43) Pub. Date: May 19, 2016

(54) USER INPUT DEVICE USING ALTERNATING CURRENT MAGNETIC FIELD AND ELECTRIC DEVICE HAVING SAME

(71) Applicant: WIDEVANTAGE INC., Seoul (KR)

(72) Inventor: Jae Yong Go, Seoul (KR)

(21) Appl. No.: 14/898,377

(22) PCT Filed: Jun. 16, 2014
(86) PCT No.: PCT/KR2014/005275

§ 371 Date: Dec. 14, 2015

(30) Foreign Application Priority Data
Jun. 15, 2013 (KR) 10-2013-0068693

(51) Int. Cl. G06F 3/0354; G06F 3/038; G06F 3/041; G06F 3/0346; G06F 3/16

(52) U.S. Cl. CPC G06F 3/03546; G06F 3/0346; G06F 3/16; G06F 3/0414; G06F 3/0416; G06F 3/0383; G06F 2203/04101; G06F 2203/04106; G06F 2203/04105

(57) ABSTRACT

A user input device uses an alternating magnetic field, which is configured to accurately transmit and process a location, a direction and the like requested from a user by using the alternating magnetic field. The user input device using the alternating magnetic field includes a power source, a magnetic field generation unit, and a control unit which receives power and controls the magnetic field generation unit involved in generating and blocking the alternating magnetic field. Also, an electric apparatus includes a magnetic field sensor that detects the alternating magnetic field from the user input device.

### TECHNICAL FIELD

The present disclosure relates generally to a user input device and an electric apparatus having the same. More particularly, the present disclosure relates to a user input device using an alternating magnetic field, which is configured to accurately transmit and process a location, a direction and the like requested from a user by using an alternating magnetic field, and to an electric apparatus having the same.

### BACKGROUND ART

A touch screen, which is a pointing device used in tablets, smart phones or other interactive screens has a sensor for sensing capacitive, resistive or optical touches on a display screen such that a user is allowed to press or drag directly an object displayed on the screen. In particular, in the case of a capacity touch screen, a user makes a touch with a stylus pen nib made of conductive materials. In the case of a resistive touch screen, a user makes drawing inputs on the touch screen simply by applying a mechanical pressure of the tip of a stylus pen, or general pointing device inputs such as selecting a menu, dragging and the like. Also, a user may make these inputs using a finger. However, most of the capacitive/resistive touch screens are not capable of distinguishing inputs that are made as a person presses his or her skin against the touch screen from inputs that are made by a pressed pen. As such, a user should not rest the palm of a writing hand on the screen while writing with the pen, but should raise the writing hand above, thereby making the writing operation difficult and unnatural. Moreover, since these types of touch screens take only 2D inputs of the nib pressing the screen, they are not capable of measuring the tilt direction or angle of a pen holder or the press pressure applied against the screen in order to intuitively change the thickness or boldness of a pen stroke, or of carrying out a 3D operation.

Certain types of smart phones can distinguish a stylus pen input from a finger input, and receive a press input. But these may be realized only when a touch screen is provided with a high-priced, two-layer sensor, or a high-priced pen equipped with such an expensive sensor, a microprocessor, a data communication module and a power source. For instance, some of Samsung smart phones and tablets have incorporated a technology which combined a capacitive technique and magnetic resonance, as disclosed in patents (U.S. Pat. Nos. 5,134,388; 5,898,136; 8,228,312 and so on) to Wacom Co., Ltd., Japan, such that they are capable of distinguishing pen inputs from hand-press inputs as well as measuring the degree of pressing force of the pen, i.e. pen pressure. This method, however, incurs more costs even for the implementation of a corresponding touch screen, and requires a complicated circuit and power source for the pen.

U.S. Patent Application No. 2012/0127110 of Apple Inc., and U.S. Patent Application No. 2012/0153026 of Microsoft Corp. describe a stylus pen comprising a camera, a circuit with a power source, a processor and a wireless communication module. When the nib of a stylus pen is sufficiently close to or touches the screen of a smart phone, a fine visual sign is formed on the screen, which is then recognized by the camera in the stylus pen such that the screen may recognize the location of the nib on the screen and distinguish between touches by the pen and touches by a hand which is not a pen. Nevertheless, this pen equipped with a camera, a high-priced processor, a Bluetooth communication module and a power source causes a large increase in the manufacturing cost.

These touch-based screen input devices are not limited to pen forms, but may be configured in a variety of forms including a toy car or a gaming puck, for example, available in Appmates products from Spin Master Ltd., U.S.A. Such phone/tablet accessories have at least one conductive contact such as conductive silicone at their bottom, so when an accessory is placed on a touch screen, a sensor in the touch screen finds out where the accessory is placed. Having multiple conductive contacts and a multi-touch function with multiple contacts makes the device possible to obtain not only 2D information which simply corresponds to location coordinates but rotation information as well of an accessory placed. However, because of the nature of a capacitive screen, each conductive contact should be at least 6 mm in diameter, and the bottom of an accessory should be almost flat and sufficiently broad for those conductive contacts to touch simultaneously, which makes it difficult to have an intuitive input according to tilt of the accessory.

Besides a touch screen, a track pad, although not displaying, is broadly used as a pointing device for dragging or selecting with a fingertip press. The touch screen and the track pad also share the similar disadvantages as the track pad does not easily distinguish between pen touches and hand touches and identify the type of a pen, and is not capable of measuring the direction and degree of tilt of a pointing device of interest.

In addition, there have been studies on the measurement of angle and location of a mobile phone by using a sensor in a portable computer. Particularly, there was an attempt for performing measurements only with software using an acceleration sensor in a given smart phone. For instance, according to the project called “Phone Point Pen” which was conducted by Duke University in the United States, the gyroscope and the accelerometer in a smart phone recognize trajectories of a letter drawn in air by the smart phone and then change them into strokes on the software. A similar study is also found in the report called “Motion Processing” by InvenSense Inc., in the United Sates, which describes that changes in speed and an angle of a moving smart phone can be measured comparatively accurately and linear displacement can also be measured through sensor fusion that removes noises and carries out proper derivative and integral operations, with reference to all inputs from the gyroscope, accelerometer and three-axis magnetic sensor (e-compass) installed in a smart phone for measuring acceleration. However, it is hard to clearly distinguish between rotational acceleration and linear acceleration, and linear displacement obtained by integrating the acceleration twice in a very noisy environment due to rapid speed changes or very fine motions such as vibrations has a substantially large accumulated error, thereby making it practically impossible to attain accuracy for using the linear displacement as an input of the pointing device. Meanwhile, when the smart phone is not in use, it is possible to obtain accurate measurement of an absolute value of direction angle of the smart phone by using the accelerometer and the magnetic field sensor under the influence of the earth-generated gravity and magnetic field in certain directions. Even when the smart phone is moving, it is possible to obtain comparatively accurate measurement of a 3D direction angle indicated by the smart phone, by filtering errors and accumulated noises through further use of a measurement value provided from the gyroscope in the smart phone as the 3D direction angle does not have a large accumulated error. In other words, while information about direction is relatively accurately measurable with the help of built-in sensors of a smart phone, information about a linear distance is not accurately measurable.

In order to find the location and direction of a magnet by measuring a magnetic field, one should know a bias of the geomagnetic field, which is determined depending on the direction of a computer on the earth, as magnetic field sensors are also influenced of the earth's magnetic field. Since noises are produced by AC electrical wires, or by severe biases by the geomagnetic field as well as any adjacent magnet or electromagnet, a magnet inside the computer and the like, a large number of (typically 9 or more) magnetic field sensors are conventionally used for measuring the location of a magnet, and calibration should be done separately. Moreover, a strong magnet is required because a magnetic field sharply decreases in proportion to the cube of a distance, but a strong magnetic field thus formed when the magnet approaches close to an electronic compass is mostly beyond the dynamic range of the electronic compass, thereby making its measurement impossible. Furthermore, when such a strong magnet approaches the sensor, a ferromagnetic material such as iron inside or outside the sensor is magnetized by hysteresis and disturbs the sensor. On the other hand, as real pens except large brushes do not much experience variations in position even though they are pressed firmly, the location of a magnet provided at the pen holder would not considerably change under the pen pressure. Accordingly, it is hard to measure the pen pressure simply by measuring the location of a magnet with the magnetic field sensor.

Considering the issues described above, it is either impossible to take a sufficiently accurate measurement of the tilt or location of the pen embedded with a simple permanent magnet or a DC-driven electromagnet, by using a magnetic field sensor in a computer, or quite inconvenient to repeat a calibration process frequently for calculating a bias by an ambient magnetic field.

### SUMMARY OF THE DISCLOSURE

In accordance with an aspect of the present disclosure, there is provided a user input device using an alternating magnetic field, which is capable of measuring the location where the nib of a stylus pen draws a stroke on a plane of a touch sensor screen, tilt direction and angle of the pen in space, a pen pressure and the like, employing only a pen (user input device) equipped with an electromagnet for generating an alternating magnetic field and a limited number of magnetic sensors, instead of employing a high-priced 2-layer touch sensor screen and a pen equipped with a complicated circuit and a power transmission unit as available from Wacom Technology for example, or without having to install at a stylus pen a high-priced sensor, a processor, a communication device such as a Bluetooth, and a power source; and to provide an electric apparatus having such a user input device.

Another aspect of the present disclosure is directed to a user input device using an alternating magnetic field, which sets a limit on motions of the user input device to reduce degrees of freedom thereof and then uses an alternating magnetic field to enable high-accuracy determination of the location and direction of the user input device, and to an electric apparatus having such a user input device.

Still another aspect of the present disclosure is directed to a user input device using an alternating magnetic field, which sets a limit on motions of the user input device and then determines the location and direction of the user input device with high accuracy based on measurements provided by location sensors available in an electric apparatus and measurements of the alternating magnetic field provided by the user input device, and to the electric apparatus having such a user input device.

Yet another aspect of the present disclosure is directed to a user input device using an alternating magnetic field, which enables high-accuracy determination of the location and direction of the user input device with combined use of an alternating magnetic field and sound information, and to an electric apparatus having such a user input device.

The user input device using an alternating magnetic field according to the present disclosure includes a power source, a magnetic field generation unit, and a control unit which receives power from the power source and controls the magnetic field generation unit involved in generating and blocking an alternating magnetic field.

In a further embodiment, the magnetic field generation unit generates an alternating magnetic field having at least one frequency or a frequency band.

In a further embodiment, the magnetic field generation unit is composed of a coil; or of a permanent magnet and a motor for rotating the permanent magnet; or of a rotatable permanent magnet and a wound coil disposed at a certain distance from the rotatable permanent magnet.

In a further embodiment, the user input device further includes a pressure sensor having variable electrical properties depending on an applied pressure.

In a further embodiment, the control unit changes at least one of frequency and amplitude of an alternating magnetic field generated by the magnetic field generation unit in correspondence to the varied electrical properties of the pressure sensor.

In a further embodiment, the magnetic field generation unit includes a first magnetic field generator, and a second magnetic field generator having a frequency different from that of an alternating magnetic field generated by the first magnetic field generator or having an alternating magnetic field generation time different from that of the first magnetic field generator.

In a further embodiment, the user input device includes first and second speakers for generating sounds, or first and second microphones for detecting sounds.

In a further embodiment, the first and second speakers are arranged symmetric with respect to the magnetic field generation unit, or arranged along an extension line of a dipole axis of the magnetic field generation unit.

In a further embodiment, the electric apparatus of the present disclosure includes a magnetic field sensor for detecting an alternating magnetic field from the user input device, and a control unit which calculates location and direction of the user input device from the detected alternating magnetic field.

In a further embodiment, the magnetic field sensor includes at least three single-axis sensors or three-axis sensors.

In a further embodiment, the control unit of the electric apparatus processes a program currently being carried out or indicates a stroke through a display unit of the electric apparatus, with reference to the calculated location and direction.

In a further embodiment, the control unit of the electric apparatus verifies information on a pen pressure or distinguishes a touch by the user input device from others, with reference to a frequency or amplitude being changed.

In a further embodiment, the electric apparatus further includes a gyroscope and an accelerometer, and the control unit of the electric apparatus considers measurements taken from both the gyroscope and the accelerometer for consideration.

In a further embodiment, the electric apparatus includes first and second speakers for releasing sound to the user input device, or first and second microphones for detecting sound from the user input device.

In a further embodiment, the control unit of the electric apparatus saves information on frequency of an alternating magnetic field of the user input device, and performs filtering on magnetic field values provided by the magnetic field sensor using the saved information on frequency.

In a further embodiment, the control unit of the electric apparatus processes and uses only a magnetic field strength of a frequency or a frequency band that indicates a larger magnetic field strength than other magnetic field strengths of other frequencies or frequency bands among the magnetic field values provided by the magnetic field sensor.

In a further embodiment, the control unit of the electric apparatus calculates a tilt angle and a tilt direction of the user input device with respect to the front surface or reference plane of the electric apparatus.

In a further embodiment, the control unit of the electric apparatus determines and processes thickness or boldness, or cursive style of a stroke with reference to the tilt angle and the tilt direction.

In a further embodiment, the electric apparatus includes a touch screen or a track pad for sensing proximity or touch of an end of the user input device.

According to the present disclosure, not only a trace that is created by the user when pressing the nib against a touch screen but also the boldness or thickness of a stroke as in writing on a piece of paper using a pen may naturally be input to an electric apparatus, through pen tile and a pen pressure applied to the touch screen. The present disclosure also resolves the problems of a conventional touch pen that the user has to raise his or her hand above the screen as the touch pen is incapable of distinguishing between hand touches and pen touches

To measure even a motion of the user input device (pointing device), which cannot be measured only with a limited number of magnetic field sensors including a three-dimensional mouse moving with a large degree of freedom, the present disclosure incorporates a general-purpose touch screen or microphone already available in a portable computer together with an additional input device, thereby enabling to obtain accurate information on the location and direction of the user input device.

According to the present disclosure, the magnetic field generation unit in the user input device is configured to generate an alternating magnetic field. Also, only magnetic field components of a certain frequency are filtered from those magnetic field values measured by magnetic field sensors in the electric apparatus, which in turn allows to remove biases and noises by a geomagnetic field or other ambient magnetic fields having a frequency different from that of a magnetic field of the user input device such that the user does not need to perform a calibration process and the accuracy thereof is improved. Moreover, even if an electromagnet of the user input device may generate a relatively small magnetic force, a signal is still detected and therefore, accurate measurements can be performed with a sensor of a reasonable dynamic range even when the user input device moves in a rather large area. Since the magnetic field components applied by a ferromagnetic body inside the sensor, which was magnetized by a magnetic field of strong DC or AC components in surroundings, also have a frequency different from that of a magnetic field generated in the user input device, they are removed through a filtering process and therefore, the location and direction of the user input device can be measured accurately. For instance, by setting the frequency of a magnetic field generated in the user input device to 17 Hz and by filtering only magnetic components of 17 Hz from those magnetic components sensed in the electric apparatus, it is possible to remove magnetic field noises that are generated by an ambient high-voltage 60 Hz alternating current. In addition, by eliminating ambient magnetic field effects from the geomagnetic field corresponding to a DC or by any adjacent magnet through a filtering process, the user does not need to perform calibration for improving a bias by an ambient magnetic field.

Furthermore, a combined use of the touch screen or microphone available in the electric apparatus together with an additional input device enables to measure even a motion of the user input device, which cannot be measured only with a limited number of magnetic field sensors. As such, it is possible to produce a three-dimensional mouse moving with a large degree of freedom in a simple, low-cost manner.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a schematic diagram of a first exemplary embodiment of a user input device and of an electric apparatus having the same according to the present disclosure.

FIG. 2 shows a first exemplary use of FIG. 1.

FIG. 3a to FIG. 3d are exemplary embodiments of a magnetic field generation unit 10 of FIG. 1.

FIG. 4 shows a second exemplary use of FIG. 1.

FIGS. 5a and 5b show a second exemplary embodiment of the user input device, and an exemplary use of the user input device according to the second exemplary embodiment and of an electric apparatus.

FIGS. 6a and 6b show a third exemplary embodiment of the user input device, and an exemplary use of the user input device according to the third exemplary embodiment and of an electric apparatus.

FIGS. 7a and 7b show a fourth exemplary embodiment of the user input device, and an exemplary use of the user input device according to the fourth exemplary embodiment and of an electric apparatus.

FIG. 8 shows an exemplary use of a user input device according to a fifth exemplary embodiment and of an electric apparatus.

### DESCRIPTION OF THE PREFERRED EMBODIMENT

Hereinafter, the present disclosure will be described in detail with reference to the exemplary embodiments and accompanying drawings.

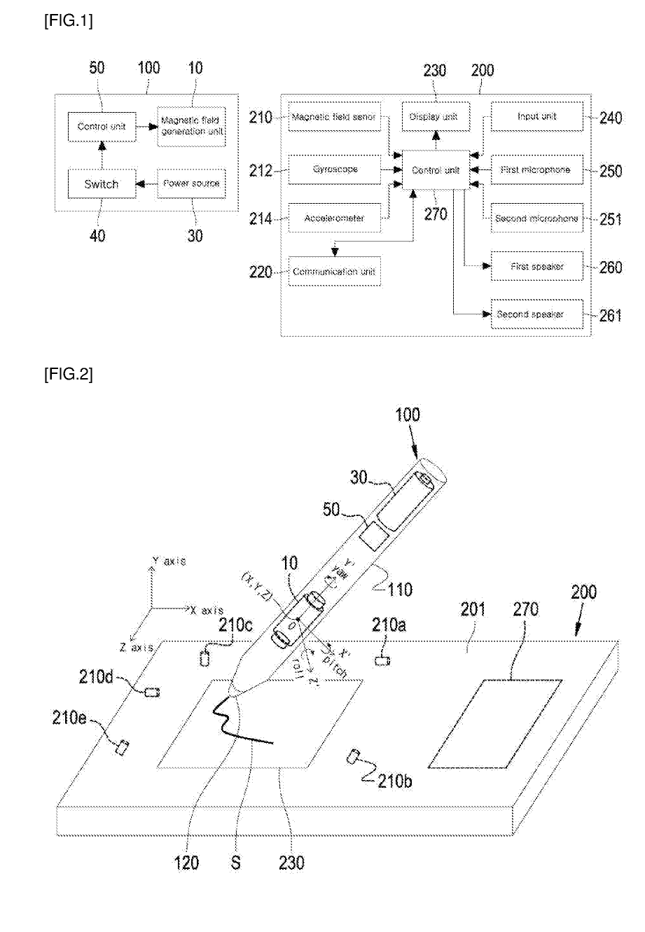

FIG. 1 is a schematic diagram of a first exemplary embodiment of a user input device and of an electric apparatus having the same according to the present disclosure.

The user input device 100 may include a magnetic field generation unit 10 for generating an alternating magnetic field, a power source 30, a switch 40 for allowing or blocking power supply from the power source 30 to the magnetic field generation unit 10 and a control unit 50, and the control unit 50 for controlling the magnetic field generation unit 10 using the power source 10 to generate or block an alternating magnetic field having at least one preset frequency or frequency band. The switch 40 may be optionally provided.

An alternating magnetic field generated by the magnetic field generation unit 10 is a magnetic field that has varying polarity or magnitude with time according to a pattern (frequency, period) known to an electric apparatus 200. For example, it can be a magnetic field in which the N pole and the S pole vary according to a sine function or a sawtooth function at regular period. Also, it is desirable that the magnetic field generation unit 10 is either electromagnet to which a constant-frequency alternating current is applied, or a permanent magnet which rotates at a constant angular velocity.

The control unit 50 receives power from the power source 30 and applies a sine wave or sawtooth AC voltage to the magnetic field generation unit 10 such that an alternating magnetic field generated therein may have at least one preset frequency or frequency band.

The electric apparatus 200 includes a magnetic field sensor 210 for measuring a magnetic field, a gyroscope 212, an accelerometer 214, a communication unit 220 for performing communications according to a variety of communication protocols, a display unit 230 for displaying diverse information, an input unit 240 for acquiring user inputs, first and second microphones 250, 251 for acquiring external sound/voice signals, first and second speakers 260, 261 for releasing (emitting) sounds/voices to outside, and a control unit 270 for controlling these components described above to carry out unique functions (wired/wireless communications, image play and the like) of the electric apparatus 200 and to calculate the location and direction of the user input device 100 through the measurement of a magnetic field from the user input device 100. Although not shown, there is a power source, but its detailed explanation is omitted as it is a component of well-known technology. For the same reason, detailed explanations on the gyroscope 212, the accelerometer 214, the communication unit 220, the display unit 230, the input unit 240, the first and second microphones 250, 251, the first and second speakers 260, 261 are not provided.

The magnetic field sensor 210 may be composed of hall sensors configured to measure one-dimensional magnetic field values, or a two- or three-dimensional magnetometer. A multi-dimensional sensor has the same effects as an equivalent number of one-dimensional sensors.

When the magnetic field generation unit 10 generates an alternating magnetic field of a preset frequency (e.g., 17 Hz) or frequency band, the control unit 270 of the electric apparatus 200 performs a Fourier Transformation on magnetic field values at multiple time points obtained from the magnetic field sensor 210, and takes only a certain signal magnitude within the preset frequency or frequency band among all of the frequency bands for reference. That is, such a frequency filtering operation of the control unit 270 of the electric apparatus 200 makes is possible to remove incoming noises over broad frequency bands and to eliminate all the influences of ambient magnetic fields including a geomagnetic field without a frequency, for example. This filtering (extraction) of a preset frequency can be done by the control unit 270 through the operation of a lock-in amplifier or performing a numerical computation algorithm such as a Fourier Transformation.

In other words, besides an alternating magnetic field generated in the user input device 100, the geomagnetic field that is applied to anywhere on the earth and the ambient magnetic field that is continually provided from internal/external magnets of the electric apparatus 200 also affect a magnetic field value measured in the magnetic field sensor 210. If the electric apparatus 200 is a portable type one, the ambient magnetic field is an unknown three-dimensional variable that changes by a direction on the earth seen from the electric apparatus 200. In addition, depending on the type of the magnetic field sensor 210 used, a ferromagnetic body such as a concentrator for changing the direction of a sensed magnetic field may be embedded in the sensor. Also, if a ferromagnetic material such as iron is present close to the magnetic field sensor 210, the ferromagnetic material around the sensor is magnetized by soft iron effects (hysteresis) as a magnet draws closer to or moves away from the magnetic field sensor 210, which results in severe malfunction of the magnetic field sensor 210. Since those ambient magnetic fields or those magnetic fields having a hysteresis phenomenon are mostly magnetic fields free of alternating current components, the magnetic field generation unit 10 may generate a magnetic field within a preset frequency or frequency band, or the electric apparatus 200 may filter only a certain magnetic field signal within the preset frequency or frequency band among all of the measurement values from the magnetic field sensor 210 for reference, to thus remove errors by an ambient magnetic field or a hysteresis phenomenon. Furthermore, most of electromagnetic field noises produced in an AC power supply around the electric apparatus may be removed if the magnetic field generation unit 100 generates an alternating magnetic field at a frequency different from the frequency of the AC power supply (50 Hz or 60 Hz) by a certain range. In particular, it is possible to exclude any unknown magnetic field or noises generated by external factors and measure only a magnetic field change by the user input device 100, without performing calibration, e.g., swinging the electric apparatus 200 in an “8” shape, which is often demanded in a magnetic field measurement system.

When the magnetic field generation unit 10 according to the present disclosure generates an alternating magnetic field at a preset frequency A, the control unit 270 of the electric apparatus 200 performs a Fourier Transformation on magnetic field values at a number of time points obtained from the magnetic field sensor 210, and takes only a signal magnitude corresponding to the frequency A among other signal magnitudes within a given frequency band. This allows to remove noises included over broad frequency bands and to eliminate all the influences of ambient magnetic fields including a geomagnetic field without a frequency, for example.

Moreover, even if the control unit 270 may not have a pre-stored frequency A or there is no preset frequency A, the control unit 270 can check whether there is a narrow frequency band where relatively a lot more signals are captured by frequency, decide a certain frequency within the narrow frequency band as the frequency of an alternating magnetic field generated by the magnetic field generation unit 10, and process the magnitude of a signal within the decided narrow frequency band as the magnitude of a magnetic field generated by the magnetic field generation unit 10. Then the control unit 270 uses the thus determined magnitude of a magnetic field only to calculate the location and direction of the user input device 100.

FIG. 2 shows a first exemplary use of FIG. 1. The user input device 100 includes a pen-shaped case 110 embedded with a magnetic field generation unit 10, a power source 30 and a control unit 50, and an end part 120 at one end of the case 110.

The electric apparatus 200 includes a limited number of one-dimensional magnetic field sensors 210a-210e, e.g., Hall sensors, which are arranged at a distance from each other, a display unit 230 on a front face 201, and a built-in control unit 270. Other components in FIG. 1 are not shown as they are not necessary in this exemplary embodiment.

The control unit 270 of the electric apparatus 200 receives and processes a magnetic field sensor 210a-210e input, and the display unit 230 displays a user input according to an input alternating magnetic field in form of a stroke S. For this processing on the alternating magnetic field, the control unit 270 of the electric apparatus 200 has a non-linear function (alternating magnetic field processing algorithm) saved in form of software, for calculating which magnitude of a magnetic signal is detected in the respective location and direction in relative space from the magnetic field generation unit 100.

If these magnetic field sensors 210a-210e having degrees of freedom equal to or larger than those of motions of the magnetic field generation unit 10 are linearly independently installed within a sufficiently close distance from the magnetic field generation unit 10, the electric apparatus 200 can find the location and direction of the magnetic field generation unit 100 in space that best describe magnitudes of alternating magnetic field signals through a non-linear function B, with reference to the magnitude of an alternating magnetic field from each of the magnetic field sensors 210a-210e. Accordingly, it is possible to calculate the location (x, y, z) and direction (roll, pitch) of the magnetic field generation unit 10 on the coordinate system (X-axis, Y-axis, Z-axis) of the front face 201. In other words, the magnetic field generation unit 10 calculates a location and direction vector (x, y, z, roll, pitch) in which a difference between actual magnetic field signal magnitudes that affect the respective magnetic field sensor 210a-210e and signal magnitudes that are calculated through the non-linear function B becomes minimal according to a predetermined reference. This can be obtained by performing a non-linear optimization process on an equation including the above five variables, and a non-linear function and alternating magnetic field values being measured, or by performing a numerical computation algorithm for obtaining solutions of the equation.

Here, the non-linear function B is determined in various ways, taken the shape and size of the magnetic field generation unit 10, the strength of a magnetic field (moment) or the like into consideration. For instance, if a gap (distance) between the magnetic field generation unit 10 (magnet) and the magnetic field sensor 210 is larger than the size of the magnetic field generation unit 10 (magnet), the magnetic field generation unit 10 (magnet) is considered as a point type magnet, and this can be expressed in a simple function. Given that the direction is directed from the S pole to the N pole of a magnet, size of a dipole vector of the magnet, that is, a magnetic field vector \vec{B} applied to a sensor location by the magnet is determined by Equation 1 below:

$$\vec{B} = \frac{1}{{r}^{3}} [ 3 ( \vec{μ} \cdot \hat{r} ) \hat{r} - \vec{μ} ]$$

wherein \vec{μ} is a magnetic field strength vector, \hat{r} is a vector starting from the location of a point-type magnet and arriving at the location of a sensor measuring a magnetic field, i.e. (sensor location vector)-(point-type magnet location vector), and r is the size of \hat{r}.

Meanwhile, the B function of Equation 1 is an equation that describes how a magnetic field value \vec{B} is determined with respect to the location and direction of a magnetic at a time point. However, the equation should be applied differently since the magnetic field generation unit 10 (magnet) according to the present disclosure generates an alternating magnetic field and the electric apparatus 200 calculates the size of a specific frequency component of a signal from measurement values at different time points. As such, the same equation can be applied, provided the magnetic field vector \vec{B} indicates the size of a specific frequency component, in each coordinate axis direction, of an alternating magnetic field that is applied by the magnetic field generation unit 10 (magnet (the source of a magnetic force)) at the location of the magnetic field sensor 210, and the size of \vec{μ} indicates the strength of a specific frequency component of an alternating magnetic field generated by the source of a magnetic force.

Also, variables for describing the location and direction are found in various ways, for example, by obtaining (x, y, z, roll, pitch) of a closest value to an actually detected value by the magnetic field sensor 210a-210e among other size vectors of all of the magnetic field signals that can be detected in the magnetic field sensor 210a-210e by possible location and direction vectors of the magnetic field generation unit 10 or interpolating several of those obtained candidate variables.

The control unit 270 calculates a three dimensional location of the end part 120 of the case 110 from the three dimensional location and direction of the magnetic field generation unit 10 thus obtained. Since a locational relationship between the end part 120 and an origin O is already saved in the control unit 270 of the electric apparatus 200, the control unit 270 determines a three dimensional location of the end part 120 using the pre-saved locational information from the location and direction of the magnetic field generation unit 10. When the end part 120 is close to the front face 201 or the display unit 230 such that a gap therebetween is not greater than the reference difference, the control unit 270 decides that the end part 120 has touched the front face 201 or the display unit 230, and then makes a currently running software into a touch event. According to this touch event, the software and output states and contents are updated, and a corresponding feedback is given to the user through the display unit 230. As illustrated, the stroke S may be shown on the display unit 230.

The control unit 270 can compare the direction Y′ of the magnetic field generation unit 10 with a normal vector (Y-axis) of the front face 201, and calculate a tilt angle theta (the degree of tilt) and a tilt direction phi (azimuthal angle) (the tilted direction) of the user input device 100 on the front face (201) (reference surface). In the case the electric apparatus 200 is carrying out a writing software, it can check whether such a touch was made and refer the location of the end part 120 that was touched to decide the location of a stroke S to be shown on the display unit 230, adjust the boldness or thickness of a stroke S being drawn from the tilt angle of the magnetic field generation unit 10 to display (output) the adjusted stroke, and create an effect as if the pen were actually dipped in ink by making further reference to the azimuthal angle and making the stroke S cursive for example.

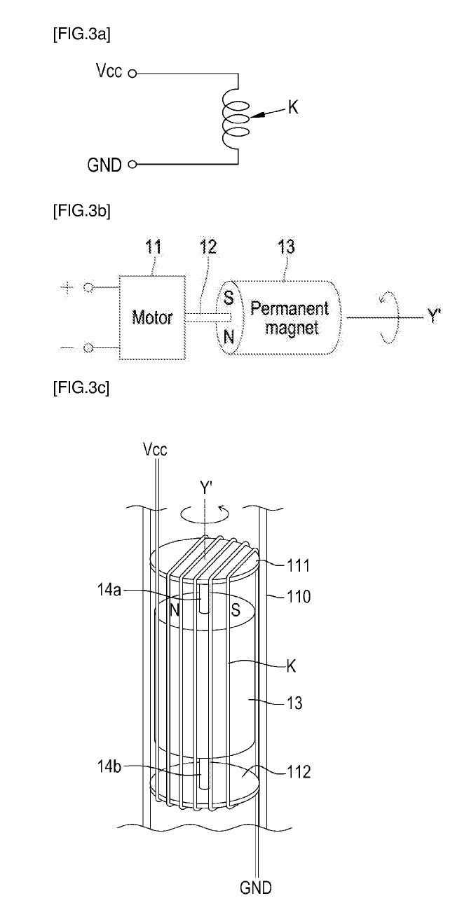

FIGS. 3a to 3d are exemplary embodiments of a magnetic field generation unit 10 of FIG. 1.

On one hand, the magnetic field generation unit 10 in FIG. 3a is composed of a coil K to which AC voltage Vcc is applied from the control unit 50. The coil K is wound around an area or space of a uniform diameter and securely mounted in the case 110. The coil K generates an alternating magnetic field by performing an operation comparable to an electromagnetic. The control unit 50 applies a sine wave or sawtooth AC voltage Vcc to the coil K.

On the other hand, the magnetic field generation unit 10 of FIG. 3b is composed of a motor 11, a shaft 12 and a permanent magnet 13, in which the motor 11 rotates the shaft 12 using a DC voltage (or an AC voltage) supplied from the control unit 50, the shaft 12 connects the motor 11 and the permanent magnet 13, and the permanent magnet 13 rotates by a rotational force provided from the motor 11 via the shaft 12.

The permanent magnet 13 is a cylinder-shaped, horizontally magnetized (magnetized in a direction perpendicular to the shaft) dipole, and it is desirable to install the permanent magnet 13 such that the dipole axis Y′ thereof coincides with the central axis of the user input device 100 of FIG. 2. As the permanent magnet 13 rotates, a rotation-symmetric magnetic field is generated with respect to the axis Y′. Also, the rotation of the permanent magnet 13 about the Y′ axis (yaw) does not affect a magnetic field value of the magnetic field sensor 21. Therefore, a motion of the permanent magnet 13 may be explained by 5 degrees of freedom including the central location (x, y, z) and the rotational angles (roll, pitch) about the X′ and Z′ axes that are independent of the Y′ axis.

FIG. 3c is a partial cutaway of the user input device 100 in FIG. 2, in which the magnetic field generation unit 10 is composed of a cylinder-shaped permanent magnet that is rotatably arranged inside the case 110 and magnetized in a direction perpendicular to the shaft, and a coil K wound in the direction of the shaft of the permanent magnet 13 inside the case 110, keeping a certain distance from the permanent magnet 13. The permanent magnet 13 is a horizontally magnetized dipole. Shafts 14a, 14b are securely mounted onto the top and bottom surfaces respectively, yet these shafts 14a, 14b are arranged in a rotatable manner on the bottom surface of a fixed plate 111 and the top surface of a fixed plate 112, respectively. For example, a groove is formed in the bottom surface of the fixed plate 111 and the top surface of the fixed plate 112, respectively, and part of each shaft 14a, 14b is inserted into a corresponding groove and rotatably disposed therein. While the coil K in FIG. 3c is wound around the fixed plates 111, 112 in the shaft direction, it may be wound in various ways, provided it maintains a certain space from the permanent magnet 13. As illustrated in FIG. 3b, the shafts 14a, 14b are installed to be coincident with the Y′ axis. Also, as in FIG. 3a, the coil K receives an AC voltage Vcc from the control unit 50 and produces an electric field to cause the rotation of the permanent magnet 13.

FIG. 3d shows a magnetic field generation unit 10 similar to one in FIG. 3c, except that a globular-shaped permanent magnet 15 instead of the cylinder-shaped permanent magnet 13 is rotatably installed inside the case 110. Fixed plates 113, 114 for restricting a vertical motion of the permanent magnet 15 are provided on the upper and lower sides of the permanent magnet 15. But it should be noted that a space between the fixed plates 113, 114 needs to be kept large enough for the permanent magnet 15 to be able to rotate. Again, as in FIG. 3a, the coil K receives an AC voltage Vcc from the control unit 50 and produces an electric field to cause the rotation of the permanent magnet 15.

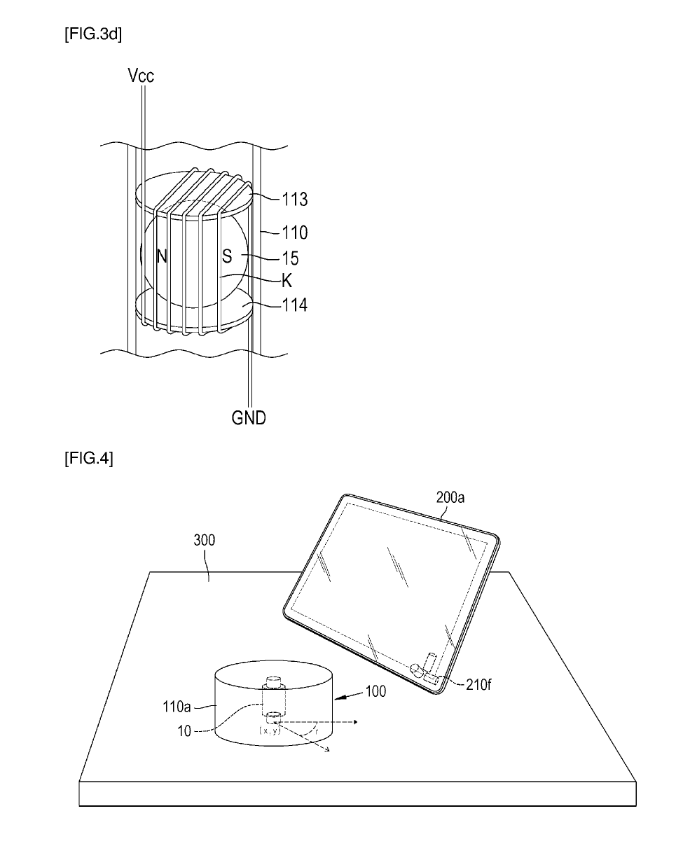

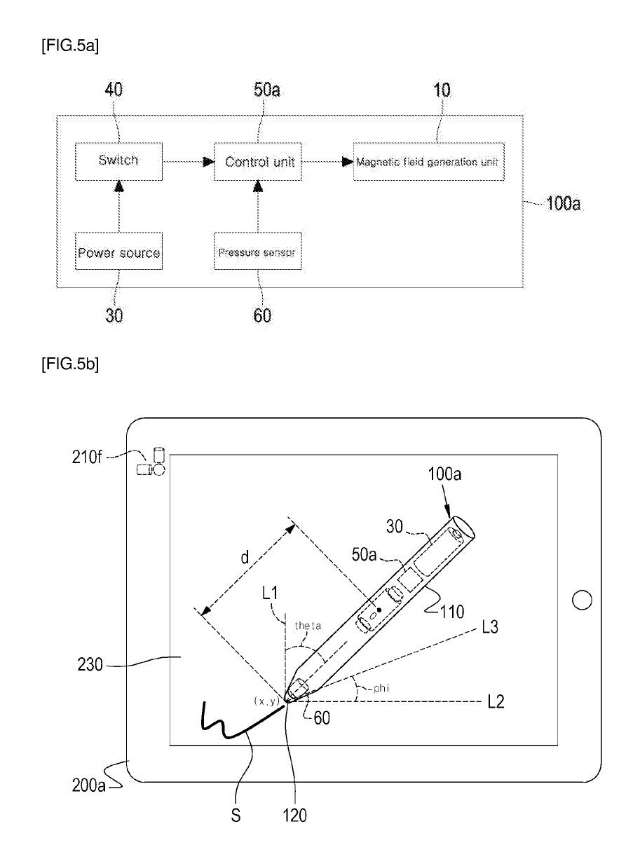

FIG. 4 shows a second exemplary use of FIG. 1. The user input device is not particularly limited to a pen shape, but may be produced in other shapes including a three-dimensional mouse or knob. While FIG. 2 illustrated an exemplary embodiment where five sensors are used to measure the location and direction of a pen-shaped user input device 100 moving in air, FIG. 4 illustrates a user input device 100 composed of a planar mouse-shaped case 110a. The user input device 100 also includes a power source 30, a switch 40 and a control unit 50, but these are not included in this figure.

The electric apparatus 200 has the same components as those of the electric apparatus 200 of FIG. 2, except that the magnetic field sensor 210 in this embodiment is provided with a 3-axis sensor.

If the user input device 100 in FIG. 4 supposedly moves in tight contact with a plane 300, degrees of freedom of the motion of the magnetic field generation unit 10 inside the case 110a are 3, including a central location (x, y) of the magnetic field generation unit 10 on the plane 300 and an angle r of the mouse on the plane 300. Therefore, with this 3-axis magnetic field sensor 210, the control unit 270 is able to calculate the location and angle of the user input device 100.

In this case, to find out whether the user input device 100 is being dragged over the plane 300 or whether it is raised up in air while moving, the case 110a may further include a force sensor or a simple opening/closing switch on its bottom surface. Then, information whether the bottom surface of the case 110a is in contact with the plane 300 can be transmitted in form of frequency modulation waves to the electric apparatus 200, or a signal can be transmitted to the electric apparatus 200 only when the bottom surface of the case 110a is dragged over the plane 300. The user input device 100 may also have a separate communication unit for signal transmission to the electric apparatus 200.

In the case that a rotation angle r of the user input device 100 is not needed and only location coordinates (x, y) are to be measured, as shown in FIG. 4, it is desirable that the dipole of the permanent magnet in the magnetic field generation unit 10 is arranged perpendicularly to the bottom surface of the case 110a. In this way, when the case 110a is in tight contact with the plane 300, unless the coordinates (x, y) on the plane of the magnetic field generation unit 10 are changed, a change in the angle r on the plane of the rotation-symmetric magnetic field is not sufficient to change a magnetic field to be transferred to surroundings remain. Therefore, it takes only two magnetic field sensors 210f to find the location (x, y) of the permanent magnet, i.e., the magnetic field generation unit 10, on the plane. Assuming that this mouse-shaped user input device 100 is used, and that three magnetic field sensors such as a 3-axis magnetic field sensor 210f available in an electric apparatus 200a are used to measure a magnetic field generated by the user input device 100, it is possible for the electric apparatus 200a to find out whether the user input device 100 is lifted up or being dragged over the plane 300, without using a separate switch or pressure sensor, since there is an extra mono-axial magnetic field sensor in addition to two magnetic field sensors (two of the mono-axial magnetic field sensors) for measuring the location of the user input device 100. To generalize the exemplary embodiment in FIG. 4, with the help of a physical device which reduces degrees of freedom of the motions of a pointing device, for example, by allowing an electromagnet to move at a certain angle with the plane, a flat and broad bottom of the pointing device, it is possible to measure the location or angle of the user input device 100 using only a limited number of magnetic field sensors with the degree of freedom of the pointing device. Moreover, even when a curved surface is used instead of the plane 300 as in FIG. 4, if the electric apparatus 200a has a pre-saved information on the curved surface, it can still find a possible moving path of the user input device 100. Thus, again, only a limited number of magnetic field sensors are required to calculate the location or angle of the user input device 100.

FIGS. 5a and 5b show a second exemplary embodiment of the user input device, and an exemplary use of the user input device according to the second exemplary embodiment and of an electric apparatus.

Compared with the user input device 100 of FIG. 1, a user input device 100a of FIG. 5a provides the same functions through those components indicated with like (identical) reference numerals, but further includes a pressure sensor 60 either installed inside the end part 120 or exposed to outside just like the end part 120, showing different electrical properties including a potential difference or a change in a resistance value for example according to an applied pressure to the end part 120. Also, in addition to those functions of the control unit 50 of FIG. 1, a control unit 50a in this embodiment is also involved in changing the frequency or frequency band or the strength of an alternating magnetic field generated in the magnetic field generation unit 10 in response to a change in the electrical properties from the pressure sensor 60.

In the exemplary use shown in FIG. 5b, an electrical device 200a includes a touch input unit on a display unit 230 as a type of the input unit 240, and a 3-axis magnetic field sensor 210f for measuring a three-dimensional direction of the geomagnetic field. Other components remain the same as those in the electric apparatus 200 of FIG. 1. In this embodiment, the control unit 270 can find the location and direction of the user input device 100a, with reference to additionally provided input data from the touch input unit (e.g., a touch screen, a track pad or the like) configure to sense a location (x, y) where the end part 120 has touched or was drawn close. For instance, if the location (x, y) of the end part 120 is available from the touch input unit, variables for describing the location and direction of the magnetic field generation unit 10 to keep a fixed distance d and direction from the end part 120 are reduced to two dimensions. In other words, if the location (x, y) of the end part 120 is known, it is possible to describe accurate location and direction of the user input device 100a, only with two variables, namely, an angle (theta) between the user input device 100a including the magnetic field generation unit 100 and the normal line L of the display unit 230 or touch input unit, and an angle (phi) between a projection L3 above the display unit 230 or touch input unit of the user input device 100a and a coordinate axis L2 of the display unit 230 or touch input unit. In this way, a problem with five dimensional variables mentioned above can be simplified into a problem with two dimensional variables, and finding a solution of a lower order non-linear equation is also simplified from those measurement values provided by at least two, properly arranged magnetic field sensors.

Conventional capacitive, resistive and optical touch screens are not capable of distinguishing between pen touches and palm or finger touches on the touch screen, and recognize them all as the same. Therefore, to write something on the touch screen or track pad, unlike writing something on a piece of paper, the user has to keep his hand raised up in air and touch the screen only with a fingertip or a nib, thereby making the overall writing process inconvenient and inaccurate. As shown in FIG. 5b, the use of the 3-axis magnetic field sensor 210f installed in the electric apparatus 200a brings the possibility of using one extra sensor besides two sensors, which number corresponds to the number of sensors required for finding the location of a magnet. With this extra sensor, ‘palm resting’ or ‘palm rejection’ on the touch screen is allowed.

In detail, the control unit 270 decides whether values from those three sensors including values from the extra magnetic field sensor are ones that can be detected when the magnetic field generation unit 10 (the origin O) lies at a location spaced by a preset constant, distance d, in a tilt direction at an angle of theta and phi from a touch location (x, y) known from an input through the touch screen (the location of the end part 120) and is directed towards the touch location (x, y). Here, the distance d indicates the spacing between the end part 120 and the origin O, the central point of the magnetic field generation unit 10. The distance d is already saved in the control unit 270. The control unit 270 calculates theta and phi values by performing a non-linear optimization process for obtaining theta and phi or by performing a numerical computation algorithm for obtaining other solutions, from the touch location (x, y) and the values read from the magnetic field sensor 210f. If theta and phi are turned out to be solutions within the reference range of a reference angle value, that is, if the values from those three sensors are detectable values, the control unit 270 decides that the location (x, y) corresponds to a touch of the user input device 100a (a normal input).

If the control unit 270 decides that theta and phi values cannot be calculated, or in the case where calculated theta and phi values fall outside a possible reference range available from mechanical properties of the user input device 100a, it decides that the location (x, y) does not correspond to a touch of the user input device 100a (an abnormal input).

For a normal input of the user input device 100a, the control unit 270 draws a stroke at a location that is decided to be a touch of the user input device 100a; if not, for a location that is decided to be the location of an abnormal input, the control unit 270 ignores this and allows the user to carry out ‘palm rejection’. Moreover, depending on whether it is a hand touch or a user input device 100a touch, different kinds of software tasks (operations) may be carried out. This distinguishment between touches by the user input device 100a and touches by a hand can be applied to one time point, as well as to measurement values of different time points for one stroke (a continuous, touch trace on the touch screen without any interruption), thereby increasing the accuracy even more. There are more diverse methods of distinguishment. For example, in the case of performing an algorithm that distinguishes different time points, if theta and phi values change drastically at an impossible speed (abnormal speed), the control unit 270 decides that it is not a touch of the user input device 100a.

To improve the accuracy, further to the above methods, the control unit 270 has the user designate which hand (left hand or right hand) is going to be used to operate the user input device 100a. In case that it is difficult for the control unit 270 to decide solely based on a magnetic field value whether it is a hand touch or a touch from the end part 120 of the user input device, depending on a designated value, if the right hand has been used, the control unit 270 decides the left-upper most touch location among multiple touch locations to be a touch location by the user input device 100a, and the other touch locations to be touch locations by a hand. Similarly, referring to the saved value, if the user has used the left hand, the control unit 270 decides the right-upper most touch location among multiple touch locations to be a touch location by the user input device 100a, and the other touch locations to be touch locations by a hand.

Also, ‘temporal and spatial locality’ may be used. In other words, the control unit 270 decides only those touches within a range where they are movable at a normal speed (a reference speed) of the user's hand from a touch location and time of a touch that was regarded as a touch of the user input device 100a at a nearest time point to be touches by the user input device, and other touches outside the range to be touch inputs by a hand.

The control unit 50a of the user input device 100a includes a frequency modulation circuit for changing the frequency of an alternating magnetic value generated by the magnetic field generation unit 10 based on an electric property change value from the pressure sensor, such that a magnetic field of varying frequency according to a change in the pen pressure applied to the end part 120 and the pressure sensor 60. In response thereto, the control unit 270 of the electric apparatus 200a performs demodulation to find out which frequency magnetic field within a given frequency band among other measured magnetic field values from the magnetic field sensor 210f is applied to thus detect a frequency or frequency band of the magnetic unit, and decides whether it is an input of the end part 120 corresponding to the detected frequency or frequency band. This pen pressure-dependent frequency modulation circuit can be implemented by a simple low-priced analog circuit, without using a microprocessor or data network. Information on a relationship between the frequency band or frequency and the pressure at the end part 120 is saved in the control unit 270.

Besides the frequency modulation circuit, an amplitude modulation circuit which changes the strength of a magnetic field generated by the magnetic field generation unit 10 according to a pen pressure may also be used. However, in the case that the strength of a magnetic field changes, the control unit 270 should determine whether an increase or decrease in the strength of a magnetic field measured in the electric apparatus 200a is caused by a change in the distance between the magnetic field generation unit 10 and the magnetic field sensor 210f, or by a change in the pen pressure.

Not only the frequency modulation and amplitude demodulation methods described above, but also any other modulation methods may be applied for a user input device to transmit pen pressure-related information to an electric apparatus.

When the electric apparatus 200a has one extra sensor having a degree of freedom greater than the number of degrees of freedom (i.e., 2) of a motion of the user input device 100b and thus there are a total of three sensors, the electric apparatus 200a is capable of measure the location of the user input device 100b as well as a change in the strength of a magnetic field, with reference to values from all of those sensors.

The electrical property change value of the pressure sensor 60 may be utilized for more effective performance of palm resting. The control unit 270 checks a measured alternating magnetic field, and compares a start time point of a stroke S where an applied pressure to the pressure sensor was zero and then began to increase and an end time point where the application of pressure has stopped and no more pressure is applied, with a start time point and an end time point of each touch entering the touch screen. The control unit 270 decides a touch that has started and ended at times (or within a reference time range) closest to the start and end time points of an input of the pressure sensor 60 to be a touch by the user input device 100a, and the others to be a touch by a non-user input device 100a, thereby implementing a more stable ‘hand resting’ motion.

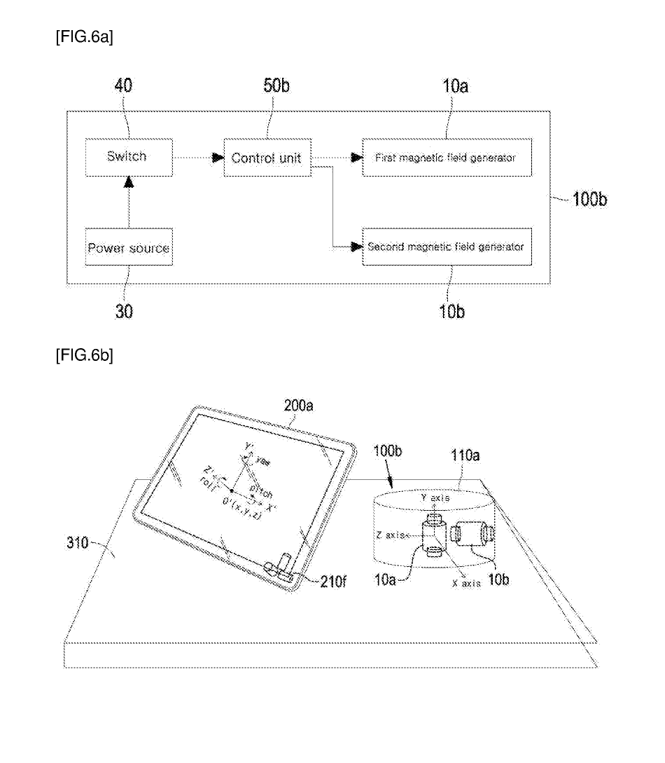

FIGS. 6a and 6b show a third exemplary embodiment of the user input device, and an exemplary use of the user input device according to the third exemplary embodiment and of an electric apparatus.

Compared with the user input device 100 of FIG. 1, a user input device 100b of FIG. 6a provides the same functions through those components indicated with like (identical) reference numerals, but further includes first and second magnetic field generators 10a, 10b for generating an alternating magnetic field. The first and second magnetic field generators 10a, 10b may generate alternating magnetic fields having the same frequency, respectively, or alternating magnetic fields having different frequencies, respectively.

In the exemplary use shown in FIG. 6b, the user input device 100b is one example, in which a case 110b embedded with the first and second magnetic field generators 10a, 10b is secured onto a plane 310, and the location and direction of an electric apparatus 200a are measured when the electric apparatus 200a is moved around by the user in a three-dimensional space.

As already discovered through the studies on existing smart phone sensor fusion, values provided from a gyroscope, an accelerometer and a 3-axis sensor embedded in most portable computers can all be used for reference, which enables comparatively accurate measurement of roll, yaw and pitch directions of a mobile phone 2, while making it difficult to sufficiently accurately measure the linear location x, y, z of the mobile phone. In contrast, as the electric apparatus 200a has 6 degrees of freedom in space, it is desirable to obtain, besides those roll, yaw and pitch, a linear coordinate (x, y, z) of the origin O′ of the electric apparatus in the coordinate system (X-axis, Y-axis, Z-axis) defined by the user input device 100b. For instance, as the first magnetic field generator 10a is a dipole, the Y-axis can be determined by a dipole of the first magnetic field generator 10a, and the X and Z axes can be determined either by referring to an azimuthal direction on the earth detected by the magnetic field sensor 210f or by referring to the direction of gravity of the earth measured by the accelerometer 214. For the coordinate (x, y, z) of the center (O′) of the electric apparatus 200a on this coordinate system, the 3-axis magnetic field sensor 210f measures a magnetic field generated by the first magnetic field generator 10a to obtain three more measurement values, and the electric apparatus 200a performs a non-linear optimization method, for example, to calculate the location and direction of 6 degrees of freedom of the electric apparatus 200a moving in space by referring the measurement values together with the roll, yaw and pitch values obtained through sensor fusion.

Particularly, when the electric apparatus 200a moves in a limited space within an octant where every coordinate on the X, Y and Z axes is positive (+), a magnetic field generated by the first magnetic field generator 10a in all of the (x, y, z) coordinates has its own direction and size distinguishable from a magnetic field in other coordinates, and the measurement of such a magnetic field enables to obtain unique (x, y, z) coordinate. If it is preferred that the spatial restriction, i.e. the electric apparatus 200a should be within an octant where the axes are all positive, should be removed, the second magnetic field generator 10b is arranged at a location or in a direction independent of the first magnetic field generator 10a, as shown in FIG. 6b. With the first and second magnetic field generators 10a, 10b generating alternating magnetic fields of different frequencies, respectively, or generating alternating magnetic fields at different time zones (time points), and therefore, with the magnetic field sensor 210f being capable of distinguishing between magnetic fields generated by the first and second magnetic field generators 10a, 10b, the control unit 270 refers two magnetic field signals and is able to measure unique (x, y, z) coordinate values when the electric apparatus 200a moves in a broader space with no spatial restriction.

For the electric apparatus 200a to calculate roll, yaw and pitch directions, the magnetic field sensor 210f should measure a geomagnetic field accurately. Even if there is a change in the magnetic fields generated by the first and second magnetic field generators 10a, 10b, considering that those magnetic fields generated by the first and second magnetic field generators 10a, 10b are alternating magnetic fields having an average value of zero, it is still possible to measure the geomagnetic field accurately using a low pass filter, for example, if those alternating magnetic fields have sufficiently high frequencies as compared with a moving speed of the electric apparatus 200a. To generalize the exemplary use shown in FIG. 6b, in the case where the user input device 100b is fixed in space and a motion of the electric apparatus 200a is to be measured, a first measurement value (although not enough) related to the location and direction of the electric apparatus 200a is obtained using sensors (the gyroscope 212 and the accelerometer 214) available in the electric apparatus 200a, and a second measurement value (although not enough) is also obtained by reading, through the magnetic field sensor 210f, alternating magnetic fields generated by the first and/or the second magnetic field generator(s) (10a, 10b). Then, the combined use of the first and second measurement values ensures a number of measurement values equal to or greater than the number of degrees of freedom of a motion of the electric apparatus 200a, thereby providing the location and direction of the electric apparatus 200a in motion.

Considering that every motion is relative, even though a user input device has been discussed as a target for measurement in the present disclosure, this can be modified. For instance, when a user input device may be fixed and an electric apparatus is a moving object, or when both the user input device and the electric apparatus are moving, relative location and directions of each other can become targets for measurement.

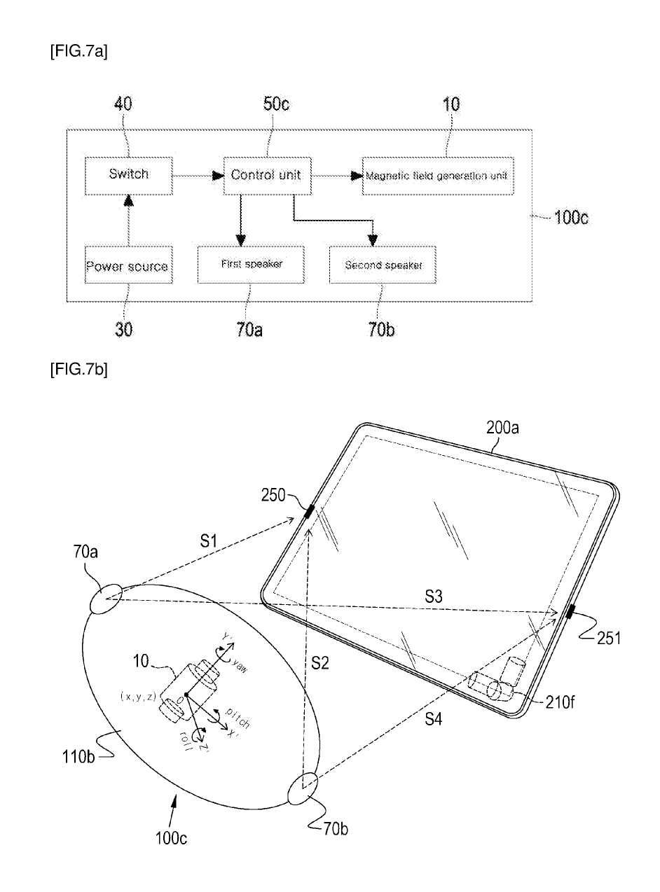

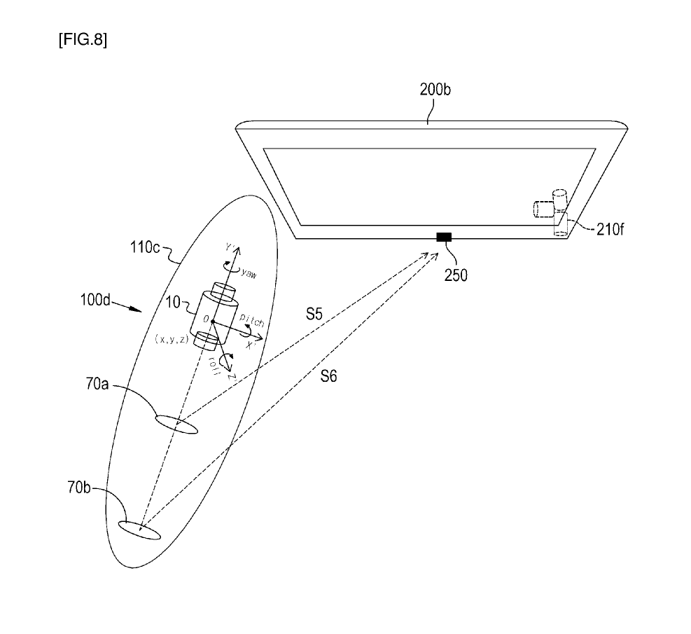

FIGS. 7a and 7b show a fourth exemplary embodiment of the user input device, and an exemplary use of the user input device according to the fourth exemplary embodiment and of an electric apparatus.

Compared with the user input device 100 of FIG. 1, a user input device 100c of FIG. 7a provides the same functions through those components indicated with like (identical) reference numerals, but further includes first and second speakers 70a, 70b for releasing sounds under the control of a control unit 50c. The first and second speakers 70a, 70b are arranged symmetric with respect a magnetic field generation unit 10.

In the exemplary use shown in FIG. 7a, an electric apparatus 200a measures a motion of the oval-shaped user input device 100c in hand-held state, moving with 6 degrees of freedom (x, y, z) and (roll, yaw, pitch) in space. In this exemplary use, the electric apparatus 200a uses a magnetic field sensor 210f together with first and second microphones 250, 251 in order to ensure a sufficient amount of data enough to measure a motion with 6 degrees of freedom of the user input device 100c.

In detail, besides having the user input device 100c generate an alternating magnetic field and having the electric apparatus 200a read a measurement value of the 3-axis magnetic field sensor 210f to obtain three pieces of information on the location and direction of the user input device 100c, the first and second speakers 70a, 70b produce sounds such as ultrasonic waves, and the first and second microphones 250, 251 of the electric apparatus 200a detect sounds. The control unit 270 ensures that additional measurand relevant to the location of the user input device 100c is secured through the application of a method for measuring a distance between the first and second speakers 70a, 70b which are sound sources and the first and second microphones 250, 251, starting from the sound propagation time.

This particular exemplary embodiment uses a limited number of speakers (sound sources) and a limited number of microphones (sound sensors) available in the user input device 100c or the electric apparatus 200a, such that the control unit 270 can measure every sound detection time between sound source-sensor pairs to obtain data relevant to a number of sounds S1, S2, S3, S4 that corresponds to a product of the number of sound sources and the number of sensors. In the case that synchronization is done on sound producing time points between the user input device 100c and the electric apparatus 200a, the electric apparatus 200a adopts a TOA (time of arrival) technique and obtains location information. In the case that no synchronization is done on sound producing time points, the electric apparatus 200a adopts a TDOA (time difference of arrival) technique, starting from the arrival time points of four sounds corresponding to S1, S2, S3 and S4 and obtains location information that corresponds to three degrees of freedom. Therefore, based on three spatial-relevant measurement values provided from the 3-axis magnetic field sensor 10 and three spatial-relevant measurement values provided by TDOA, the control unit 270 can calculate information of a motion with 6 degrees of freedom of the user input device 100c. Since the propagation of ultrasonic waves in the air is substantially directional, it is desirable that the first and second speakers 70a, 70b are arranged facing the electric apparatus 200a (or the first and second microphones 250, 251) in terms of power saving.

As an alternative exemplary embodiment of FIGS. 7a and 7b, the user input device may include first and second microphones instead of first and second speakers, and a communication unit for transmitting sound information, and the electric apparatus includes first and second speakers 260, 261 for producing sounds. In other words, the user input device obtains sound-relevant data and transmits it to the electric apparatus through the communication unit, and the electric apparatus calculates a location based on the sound-relevant data.

FIG. 8 shows an exemplary use of a user input device according to a fifth exemplary embodiment and of an electric apparatus.

In the exemplary use shown in FIG. 8, while a user input device 100d has a similar construction as the user input device 100c of FIG. 7c, an electric apparatus 200b has only one first microphone 250 such that the number of sound source-sensor pairs capable of obtaining distance-relevant information through an exchange of sounds between the first and second speakers 70a, 70b and the first microphone 250 is limited. To recognize a motion of the user input device 100d using a limited amount of measurement data, it is desirable to reduce measurement degrees of freedom of the user input device 100d. According to this exemplary embodiment of FIG. 8, the first and second speakers 70a, 70b to be used are arranged along an extension line of a dipole axis Y′ of the magnetic field generation unit 10. Under such arrangement, as the first microphone 250 and 3-axis magnetic field sensor 210f values are not affected by a yaw angle of the user input device 100d rotating around the Y′ axis, the location and direction of the user input device has 5 degrees of freedom (x, y, z, pitch, roll). Even when the user turns the user input device 100d in a yaw direction, the electric apparatus 200b cannot sense a change in the yaw angle, and as a result thereof, the state of a cursor of the software currently running, for example, stays unchanged. This restriction may be ignored when the user input device 100d serves in a variety of input devices as a gun or spear, a sword, a baseball bat, a golf club, a three-dimensional software pen for CAD or the like in computer games.

The 3-axis magnetic field sensor 210f of the electric apparatus 200b reads a magnetic field generated by the magnetic field generation unit 10 to obtain three spatial measurement values relevant to the user input device 100d, and the first and second speakers 70a, 70b measure a distance of S5, S6 through sounds provided from the first microphone 250. These five measurement values are then used for the control unit 270 to obtain the location and direction of 5 degrees of freedom of the user input device 100d. To find a distance of S1, S2, the electric apparatus 200b should know exactly when the first and second speakers 70a, 70b produce sounds (ultrasonic pulses). This clock synchronization can be achieved using any of the following methods:

1) The first and second speakers 70a, 70b are wire-connected to a headset jack of the electric apparatus 200b such that the electric apparatus 200b produces sounds once receiving outputs of the L and R (left, right) speakers. That is, sounds are produced by the first and second speakers 70a, 70b that are controllable by the control unit 270, and again, sounds produced by the first microphone 250 that is also controllable by the control unit 270 are obtained. Therefore, the control unit 270 uses a built-in timer to obtain a sound propagation delay time from the starting point when sound pulses are produced in the first and second speakers 70a, 70b to the point when the sound pulses arrived at the first microphone 250.

2) The control unit 50c induces a change in frequency/strength to a signal of the magnetic field generation unit 10 at the time when the first and second speakers 70a, 70b emit sounds. As such, if the magnetic field sensor 210f senses such a change, the control unit 270 regards the time when a magnetic field change is sensed as the time when a sound is produced and then performs synchronization.

3) The first speaker 70a releases periodic pulses, and the control unit 270 receives sounds without a sound propagation delay due to the contact with the first microphone 250, and performs synchronization through calibration which involves adjusting its timer to the time when the pulses are emitted. When the calibration is done once, the user can use the user input device 100d until a currently running software stops, without additional calibration.

As an alternative exemplary embodiment of FIG. 8, the user input device may include a microphone instead of first and second speakers, and a communication unit for transmitting sound information, and the electric apparatus includes first and second speakers 260, 261 for producing sounds. In other words, the user input device obtains sound-relevant data and transmits it to the electric apparatus through the communication unit, and the electric apparatus calculates a location based on the sound-relevant data (sound, information on sound-producing time, etc.).

In the exemplary embodiments of FIGS. 7a, 7b and 8, the user input device 100c is configured to transmit sound-relevant data to the electric apparatus 200a, 200b, such that the electric apparatus 200a, 200b may use both the sound-relevant data and the data relevant to a magnetic field (magnetic force). Having these diverse information available, instead of the magnetic field generation unit 10 for generating an alternating magnetic field, any typical magnet or permanent magnet may be installed in the user input device 100c. In the case of using such a typical magnet or permanent magnet, a control operation of the control unit 50c is neither performed or nor required.

The distinguishment between a touch input by the user input device and a touch input by a hand in a touch screen, and the measurement of an angle and pen pressure described above are not limited to an environment using a touch screen, but are applicable to any device like a track pad that receives a touch input. It should be obvious that the electric apparatus described in the present disclosure also indicates not only devices such as smart phones, tablets, PCs and laptop computers, but also general electric devices having a touch input device and a magnetic sensor that are embedded or provided via USB connections, or an operational unit capable of processing sensor inputs.

Moreover, it should be obvious that the palm resting method and the numerical computation algorithm described in the present disclosure can be made into a computer-readable program.

Further, the user input device and the electric apparatus according to the present disclosure may be combined to form a user input system using an alternating magnetic field for carrying out necessary operations.

Exemplary embodiments of the present disclosure have been described in detail in connection with the accompanying drawings. However, it will be apparent to those skilled in the art that various modifications and changes can be made thereto without changing the technical ideas or essential features of the present disclosure. Therefore, those exemplary embodiments described above are illustrative in all aspects and they should not be construed in a limitative sense.

1. A user input device using an alternating magnetic field, comprising:
a power source;
a magnetic field generation unit for generating an alternating magnetic field; and
a control unit which receives power from the power source and controls the magnetic field generation unit involved in generating and blocking the alternating magnetic field.

2. The user input device using an alternating magnetic field of claim 1, wherein the magnetic field generation unit generates an alternating magnetic field having at least one frequency or a frequency band.

3. The user input device using an alternating magnetic field of claim 1, wherein the magnetic field generation unit is composed of a coil; or of a permanent magnet and a motor for rotating the permanent magnet; or of a rotatable permanent magnet and a wound coil disposed at a certain distance from the rotatable permanent magnet.

4. The user input device using an alternating magnetic field of claim 1, wherein the user input device further comprises a pressure sensor having variable electrical properties depending on an applied pressure.

5. The user input device using an alternating magnetic field of claim 4, wherein the control unit changes at least one of frequency and amplitude of an alternating magnetic field generated by the magnetic field generation unit in correspondence to the varied electrical properties of the pressure sensor.

6. The user input device using an alternating magnetic field of claim 1, wherein the magnetic field generation unit comprises a first magnetic field generator, and a second magnetic field generator having a frequency different from that of an alternating magnetic field generated by the first magnetic field generator or having an alternating magnetic field generation time different from that of the first magnetic field generator.

7. The user input device using an alternating magnetic field of claim 1, wherein the user input device comprises first and second speakers for generating sounds, or first and second microphones for detecting sounds.

8. The user input device using an alternating magnetic field of claim 7, wherein the first and second speakers are arranged symmetric with respect to the magnetic field generation unit, or arranged along an extension line of a dipole axis of the magnetic field generation unit.

9. An electric apparatus, comprising a magnetic field sensor for detecting an alternating magnetic field from the user input device of claim 1; and
a control unit which calculates location and direction of the user input device from the detected alternating magnetic field.

10. The electric apparatus of claim 9, wherein the magnetic field sensor comprises at least three single-axis sensors or three-axis sensor.

11. The electric apparatus of claim 9, wherein the control unit of the electric apparatus processes a program currently being carried out or indicates a stroke through a display unit of the electric apparatus, with reference to the calculated location and direction.

12. The electric apparatus of claim 9, wherein the control unit of the electric apparatus verifies information on a pen pressure or distinguishes a touch by the user input device from others, with reference to a frequency or amplitude being changed.

13. The electric apparatus of claim 9, wherein the electric apparatus further comprises a gyroscope and an accelerometer, and the control unit of the electric apparatus considers measurements taken from both the gyroscope and the accelerometer for consideration.

14. The electric apparatus of claim 9, wherein the electric apparatus comprises first and second speakers for releasing sound to the user input device, or first and second microphones for detecting sound from the user input device.

15. The electric apparatus of claim 9, wherein the control unit of the electric apparatus saves information on frequency of an alternating magnetic field of the user input device, and performs filtering on magnetic field values provided by the magnetic field sensor using the saved information on frequency.

16. The electric apparatus of claim 9, wherein the control unit of the electric apparatus processes and uses only a magnetic field strength of a frequency or a frequency band that indicates a larger magnetic field strength than other magnetic field strengths of other frequencies or frequency bands among the magnetic field values provided by the magnetic field sensor.

17. The electric apparatus of claim 9, wherein the control unit of the electric apparatus calculates a tilt angle and a tilt direction of the user input device with respect to the front surface or reference plane of the electric apparatus.

18. The electric apparatus of claim 17, wherein the control unit of the electric apparatus determines and processes thickness or boldness, or cursive style of a stroke with reference to the tilt angle and the tilt direction.

19. The electric apparatus of claim 9, wherein the electric apparatus comprises a touch screen or a track pad for sensing proximity or touch of an end of the user input device.
